(19) United States
(12) Patent Application Publication
(10) Pub. No.: US 2023/0091763 A1
(43) Pub. Date: Mar. 23, 2023

(54) ENERGY-EFFICIENT ADAPTIVE PARTIAL SENSING FOR SIDELINK COMMUNICATION

(71) Applicant: Fraunhofer-Gesellschaft zur Foerderung der angewandten Forschung e.V., Munich (DE)

(72) Inventors: Dariush MOHAMMAD SOLEYMANI, Erlangen (DE); Martin LEYH, Erlangen (DE); Elke ROTH-MANDUTZ, Erlangen (DE); Shubhangi BHADAURIA, Erlangen (DE); Mehdi HAROUNABADI, Erlangen (DE)

(21) Appl. No.: 17/951,989

(22) Filed: Sep. 23, 2022

Related U.S. Application Data
(63) Continuation of application No. PCT/EP2021/057660, filed on Mar. 25, 2021.

(30) Foreign Application Priority Data
Mar. 28, 2020 (EP) 20166532.0

(51) Int. Cl. H04W 72/02; H04W 72/04; H04W 76/28

(52) U.S. Cl. CPC H04W 72/02; H04W 72/0446; H04W 76/28

(57) ABSTRACT

Embodiments provide a transceiver of a wireless communication network, wherein the transceiver is configured to operate in a sidelink in-coverage, out of coverage or partial coverage scenario, in which the transceiver is configured or preconfigured to allocate or schedule resources for a sidelink communication over a sidelink autonomously or network controlled, wherein the transceiver is configured to determine, for said sidelink communication, a set of candidate resources out of resources of the sidelink by means of partial sensing said resources of the sidelink prior to a sidelink transmission to another transceiver of the wireless communication network, wherein the transceiver is configured to perform said sidelink transmission using selected resources selected out of the set of candidate resources, wherein at least one parameter of the partial sensing depends on at least one out of
a state of the transceiver,
a state of the wireless communication network,
parameters of the sidelink or the sidelink communication.

### CROSS-REFERENCE TO RELATED APPLICATIONS

This application is a continuation of copending International Application No. PCT/EP2021/057660, filed Mar. 25, 2021, which is incorporated herein by reference in its entirety, and additionally claims priority from European Application No. 20166532.0, filed Mar. 28, 2020, which is also incorporated herein by reference in its entirety.

### TECHNICAL FIELD

The present application concerns the field of wireless communication systems and networks, more specifically to power savings for battery operated UEs when operated in an autonomous or network controlled resource selection mode. Embodiments relate to an energy-efficient adaptive partial sensing for sidelink communication.

### BACKGROUND OF THE INVENTION

FIG. 1 is a schematic representation of an example of a terrestrial wireless network 100 including, as is shown in FIG. 1(a), a core network 102 and one or more radio access networks RAN₁, RAN₂, . . . RAN_{N}. FIG. 1(b) is a schematic representation of an example of a radio access network RAND that may include one or more base stations gNB₁ to gNB₅, each serving a specific area surrounding the base station schematically represented by respective cells 106₁ to 106₅. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RAND may include more or less such cells, and RAND may also include only one base station. FIG. 1(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. Further, FIG. 1(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. Further, some or all of the respective base station gNB₁ to gNB₅ may connected, e.g. via the S1 or X2 interface or the XN interface in NR, with each other via respective backhaul links 116₁ to 116₅, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB) and a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels may further include the physical random access channel (PRACH or RACH) used by UEs for accessing the network once a UE synchronized and obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix (CP) length. A frame may also consist of a smaller number of OFDM symbols, e.g. when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g. DFT-s-OFDM. Other waveforms, like non-orthogonal waveforms for multiple access, e.g. filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB₁ to gNB₅, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g. GSM, UMTS, LTE base stations.

When considering two UEs directly communicating with each other over the sidelink, e.g. using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

In V2X applications, an available power of the so-called Vulnerable Road Users (VRUs), e.g. pedestrians, cyclists, stroller, etc., is limited, since these VRUs, such as pedestrian UEs (P-UEs), are usually depending on their UEs battery only, different to vehicle mounted vehicular UEs (V-UE). Therefore, for VRU UEs battery saving for V2X communication is essential to guarantee continuous V2X application support. One continuously energy consuming V2X procedure for the UE is sensing in autonomous resource selection mode, i.e. LTE V2X Mode 4 or NR Sidelink Mode 2, used for radio resource selection.

It is noted that the information in the above section is only for enhancing the understanding of the background of the invention and therefore it may contain information that does not form known technology that is already known to a person of ordinary skill in the art.

Starting from the above, there is a need for improvements or enhancements with respect to power savings for battery operated UEs especially when operated in an autonomous resource selection mode.

### SUMMARY

An embodiment may have a transceiver of a wireless communication network, wherein the transceiver is configured to operate in a sidelink in-coverage, out of coverage or partial coverage scenario, in which the transceiver is configured or preconfigured to allocate or schedule resources for a sidelink communication over a sidelink autonomously or network controlled, wherein the transceiver is configured to determine, for said sidelink communication, a set of candidate resources out of resources of the sidelink by means of partial sensing said resources of the sidelink prior to a sidelink transmission to another transceiver of the wireless communication network, wherein the transceiver is configured to perform said sidelink transmission using selected resources selected out of the set of candidate resources, wherein at least one parameter of the partial sensing depends on a discontinuous reception, DRX, and/or discontinuous transmission, DTX, configuration of the transceiver, wherein the transceiver is configured to perform said partial sensing and said sidelink transmission during an active period of the discontinuous transmission, DTX, and/or an active period of the discontinuous reception, DRX, wherein the parameters of the discontinuous transmission, DTX, and/or discontinuous reception, DRX, depend on at least one parameter of the transceiver or the wireless communication network, wherein the at least one parameter of the partial sensing is at least one out of
a step size describing a time interval between two consecutive sensing intervals of the partial sensing is dependent,
time instances of the partial sensing,
a duration of the sensing of the partial sensing.

According to another embodiment, a method for operating a transceiver of a wireless communication network may have the steps of: operating the transceiver in a sidelink in-coverage, out of coverage or partial coverage scenario, in which resources for a sidelink communication are scheduled or allocated autonomously or network controlled, determining, for said sidelink communication, a set of candidate resources out of resources of the sidelink by means of partial sensing said resources of the sidelink prior to a sidelink transmission to another transceiver of the wireless communication network, performing said sidelink transmission using resources selected out of the determined set of candidate resources, wherein at least one parameter of the partial sensing depends on a discontinuous reception, DRX, and/or discontinuous transmission, DTX, configuration of the transceiver, wherein the transceiver is configured to perform said partial sensing and said sidelink transmission during an active period of the discontinuous transmission, DTX, and/or an active period of the discontinuous reception, DRX, wherein the parameters of the discontinuous transmission, DTX, and/or discontinuous reception, DRX, depend on at least one parameter of the transceiver or the wireless communication network, wherein the at least one parameter of the partial sensing is at least one out of
a step size describing a time interval between two consecutive sensing intervals of the partial sensing is dependent,
time instances of the partial sensing,
a duration of the sensing of the partial sensing.

Another embodiment may have a non-transitory digital storage medium having stored thereon a computer program for performing a method for operating a transceiver of a wireless communication network, having the steps of: operating the transceiver in a sidelink in-coverage, out of coverage or partial coverage scenario, in which resources for a sidelink communication are scheduled or allocated autonomously or network controlled, determining, for said sidelink communication, a set of candidate resources out of resources of the sidelink by means of partial sensing said resources of the sidelink prior to a sidelink transmission to another transceiver of the wireless communication network, performing said sidelink transmission using resources selected out of the determined set of candidate resources, wherein at least one parameter of the partial sensing depends on a discontinuous reception, DRX, and/or discontinuous transmission, DTX, configuration of the transceiver, wherein the transceiver is configured to perform said partial sensing and said sidelink transmission during an active period of the discontinuous transmission, DTX, and/or an active period of the discontinuous reception, DRX, wherein the parameters of the discontinuous transmission, DTX, and/or discontinuous reception, DRX, depend on at least one parameter of the transceiver or the wireless communication network, wherein the at least one parameter of the partial sensing is at least one out of
a step size describing a time interval between two consecutive sensing intervals of the partial sensing is dependent,
time instances of the partial sensing,
a duration of the sensing of the partial sensing,

when said computer program is run by a computer.

### BRIEF DESCRIPTION OF THE DRAWINGS

Embodiments of the present invention are now described in further detail with reference to the accompanying drawings:

FIG. 1a-b shows a schematic representation of an example of a wireless communication system;

FIG. 2 is a schematic representation of an in-coverage scenario in which UEs directly communicating with each other are connected to a base station;

FIG. 3 is a schematic representation of an out-of-coverage scenario in which Ues directly communicating with each other receive no SL resource allocation configuration or assistance from a base station;

FIG. 4 a timeline based schematic representation of sensing time instances of the sensing-based radio resource selection procedure, when the UE is operated in NR V2X Mode 2, as well as for LTE V2X mode 4 assuming T0 is fixed to 1000 ms;

FIG. 5 shows a timeline based schematic representation of sensing time instances of the partial sensing-based radio resource selection procedure, when the UE is operated in LTE V2X Mode 4;

FIG. 6 is a schematic representation of a wireless communication system including a base station and one or more transceivers, like user devices, Ues;

FIG. 7 shows a timeline based schematic representation of a partial sensing performed by UE for radio resource selection, in accordance with an embodiment of the present invention;

FIG. 8 shows a timeline based schematic representation of a partial sensing performed by UE for radio resource selection, wherein partial sensing is performed based on sensing segments and wherein the sensing time instances are identical in all segments, in accordance with an embodiment of the present invention;

FIG. 9 shows a timeline based schematic representation of a partial sensing performed by UE for radio resource selection, wherein partial sensing is performed based on sensing segments, wherein a time shift can be applied to the sensing time instances in each segment, which make the sensing time instances differ for each segment, wherein the higher layer signaling configures the time shift offsets, in accordance with an embodiment of the present invention;

FIG. 10 shows a timeline based schematic representation of a partial sensing performed by UE for radio resource selection, wherein sensing durations of the partial sensing are variable in accordance with an embodiment of the present invention; and

FIG. 11 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings in which the same or similar elements have the same reference signs assigned.

As indicated above, there is a problem of the high power consumption for battery operated Ues, for example, Vulnerable Road Users (VRUs), e.g. pedestrians, cyclists, stroller, e.t.c. equipped with battery operated P-Ues (pedestrian Ues) using V2X applications. These pedestrian Ues (P-Ues) are usually depending on their Ues battery only, different to vehicle mounted vehicular Ues (V-UE). Therefore, for P-Ues battery saving for V2X communication is essential to guarantee continuous V2X application support. One continuously energy consuming V2X procedure for the UE is sensing in autonomous resource selection mode, i.e. LTE V2X Mode 4 or NR Sidelink Mode 2, used for radio resource selection. In Rel-17 the “NR Sidelink Enhancement” WI description [8] requests an enhancement of the existing LTE based partial sensing for the battery based P-Ues for NR V2X.

Partial sensing that shall be newly introduced for NR Sidelink for V2X (as per Work Item description [8]), therefore, consider the LTE partial sensing as the baseline. This new partial sensing for NR Sidelink has to be adapted with respect to NR specifics (e.g. support of different numerologies/sub-carrier spacings (SCS), Bandwidth Parts (BWP), NR Sidelink waveform specifics), as well as the best possible energy saving mechanism for P-Ues with minimum impact on the selection of the most appropriate radio resources.

In LTE V2X Mode 4 [1], the radio resource selection procedure is performed as follows:
Random radio resource selection
Sensing-based radio resource selection
Partial sensing-based radio resource selection

If the random radio resource selection is configured by higher layer signaling, a user will transmit on a single carrier within a resource pool, which is configured by the base station (eNB). A set of radio resources is selected and sent to the higher layer, wherein the higher layer can be an application, session, transport, RRC, RLC, PDCP, or MAC layer. This procedure is as follows:
1. A candidate subframe, Rxy, is a set of contiguous sub-channels, x+j, in a subframe, t_m, where j=0, . . . , L−1, is a set of I contiguous sub-channels within the time interval [n+Tproc,1, n+T2], the time stamp n is the packet arrival time. Tproc,1 and T2 are processing time and packet delay budget, respectively. Tproc,1 and T2 values depend on the UE implementation and should meet the following conditions:
   a. Tproc,1<=4 and T2_min(priority of TX)<=T2<=100, where the higher layer provides priority of TX, otherwise T2_min is set to 20.
2. A set of all candidate subframe resources is assumed in Sa, and an empty set of Sb is created.
3. The UE relocates a candidate subframe resource Rxy from Sa into Sb set.
4. In case, a UE is configured by the higher layer to transmit on the multiple carriers, the UE shall exclude a subframe resource Rxy from Sb, if the UE can not support simultaneous transmission due to its limitation, or not support the carrier combinations.
5. The UE shall send the Sb list to the higher layer.

When partial sensing is not configured by the higher layers, the radio resource selection is performed as follows [1]:
1. The candidate radio resources, Rxy, are a set of contiguous sub-channels L, i.e., x+j sub-channels, where j=0, . . . , L−1. Then, the UE selects a set of contiguous sub-channels from L sub-channels within [n+Tproc,1,n+T2]. Where n is packet arrival time and Tproc,1 stands for processing time, and T2 is the maximum budget delay that an incoming packet is allowed to wait before transmission wherein Tproc,11 and T2 depend on the UE implementation. Wherein Tproc,1<=4 and T2 min(priorTX)<=T2<100, and it is 4<=T2<100 when T2 min is not provided by higher layers signaling.
2. The UE monitors all m−10*Pstep subframes before time instance of m, except that subframes which are used for its transmission. Where Pstep is a step size between two consecutive sensing time instances that it is configured, as shown in Table 1. Note: The sensing time instances are a factor of a sensing step size (Pstep) and refers to the time difference between 2 consecutive sensing durations.

TABLE 1
Determination of Pstep for sidelink
transmission Mode 4 in milliseconds

| Configuration | Pstep |
|---|---|
| TDD configuration 0 | 60 |
| TDD configuration 1 | 40 |
| TDD configuration 2 | 20 |
| TDD configuration 3 | 30 |
| TDD configuration 4 | 20 |
| TDD configuration 5 | 10 |
| TDD configuration 6 | 50 |
| Others | 100 |

3. The Tha,b is a threshold that is used to identify the unoccupied subchannel, where the higher layer signaling configure it, i.e., thresPSSCH-RSRP-List-r14 SL-ThresPSSCH-RSRP-List-r14.
4. In the beginning, Sa is a set of all candidate subframe resources, and Sb is an empty set.
5. The UE excludes the candidate radio resources Rxy from the list of Sa based on the following steps:
   a. If the UE did not monitor one subframe.
   b. There exists a value of j in the equation y+j*P′rsvp_tx=z+Pstep*k*q, where j=0, 1, . . . c_resel-1 and P′rsvp_tx=P_step*P_rsvp_TX/100, and k is restricResourceReservationPeriod and q=1, . . . , Q. Note that y and z are random variables that depend on the UE implementation, and the higher layer signaling configures c_resel. Besides, Q=1/k when k<1 and therefore n′<=z+Pstep*k. Where the selected subframe belongs to the candidate subframe resources wherein the selected subframe resource can be equal to n or should be after the time instance of n. However, it should belong to the candidate subframe resources in both cases. Note that in the latter case, the value Q is equal to 1.
6. The UE should exclude a subframe resource from Rxy candidate subframe resources, from Sa, if the following conditions are met:
   c. The UE receives a SCI format-one indicating reservation of the subframe with a specific priority (parameter P_rsvp_rx and prior_rx are set in this case).
   d. RSRP of PSCCH is higher than the threshold Th_priotx, priorx configured by the higher layer signaling.
   e. If the SCI format-one received in a particular subframe indicates reserved subframe resources that overlap with the selected subframe resources by the UE.
7. If the number of selected subframe resources is smaller than 20% of total of the available subframe resources, then Tha,b value is increased by 3 dB, i.e., Step 4.
8. In case multiple carriers are configured by the higher layer signaling, a candidate subframe resources, Rxy, is excluded from Sb list when the UE does not support the multi-carrier feature.

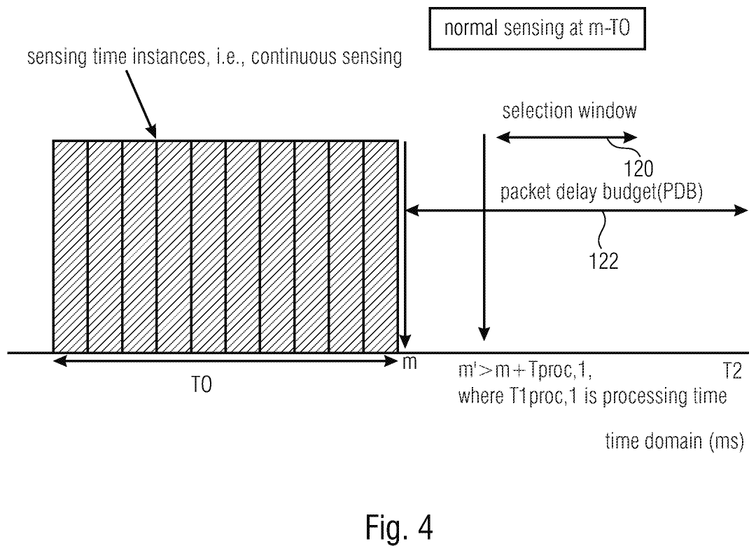

Finally, the UE will inform the higher layer about the subframe resource Sb. FIG. 4, shows the radio resource selection procedure in LTE V2X Mode 4 as explained above.

In detail, FIG. 4 shows a timeline based schematic representation of sensing time instances of the sensing-based radio resource selection procedure, when the UE is operated in LTE V2X Mode 4. As indicated in FIG. 4, the UE performs continuous sensing in the sensing window T0 prior to the time instance m, wherein m is the packet arrival time. Further, in FIG. 4, time instance m′ indicates a start of transmission, which can take place at the start of a selection window 120, wherein m′=m+Tproc,1, wherein Tproc,1 is the processing time, and T2 indicates the packet delay budget 122.

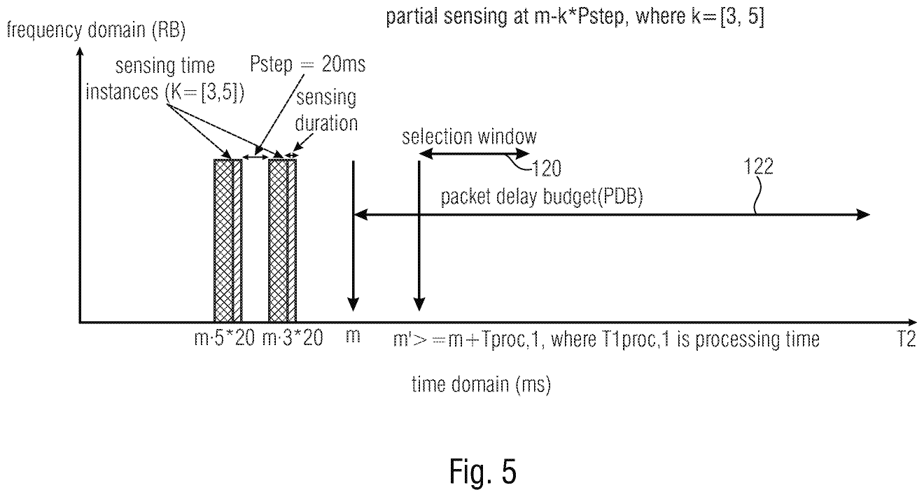

When the higher layer configures the partial sensing, then the UE performs the candidate radio resources selection as follows [1, section 14.1.1.6]:
1. Candidate radio resources for data transmission Rxy is a set of contiguous sub-channels Lsubch with x+j subchannel in subframe t_m where j=1, . . . , Lsubch, and the UE selects y subframes within the [n+Tproc,1,n+T2] wherein y depends on the UE implementation. The higher layer signaling configures Tproc,1, T2, their values depend on the UE implementation. T2 value is between T2 min(priotx) and 100 ms if the higher layer signaling configures T2 min, otherwise T2 min is 20 ms by default. Besides, the upper bound of T2 depends on the maximum delay that a packet is allowed to wait in the UE buffer before transmission. Note that y should fulfill the higher layer paparameter minNumCandidateSF within Mtotal, wherein the Mtotal is a total number of subframe resources.
2. When the k-th bit of the higher layer signaling is toggled, the UE shall monitor all t_(y−k*Pstep) subframe resources, where k is gapCandidatesensing with 10 bits which is configured by the higher layer signaling.
3. FIG. 5 represents the sensing time instances monitored by a P-UE when partial sensing is configured. In detail, FIG. 5 shows a timeline based schematic representation of sensing time instances of the partial sensing-based radio resource selection procedure, when the UE is operated in LTE V2X Mode 4. As indicated in FIG. 5, the UE performs, prior to the time instance m, partial sensing at sensing time instances m−k*Pstep for k=[3,5], i.e. at time instances m−5*Pstep and m−3*Pstep, wherein in FIG. 5 it is exemplarily assumed that Pstep=20 ms. Further, in FIG. 5, time instance m′ indicates a start of transmission, which can take place at the start of a selection window 120, wherein m′=m+Tproc,1, wherein Tproc,1 is the processing time, and T2 indicates the packet delay budget 122.
4. The parameter Tha,b is set by the higher layer signaling as indicated in SL-ThresPSSCH-RSRP.
5. Sa is a list of all candidate subframe resources, and Sb is an empty set.
6. The UE excludes any subframe resources from the set Sa that meet all of the following conditions:
   a. The UE decodes a SCI format-one indicating the resource reservation and priority, i.e., ‘resource reservation’ and ‘priority’. The parameter priorx is derived from the “priority’ field.
   b. Measured PSSCH-RSSP is higher than Th(priotx,priorx) value.
   c. The UE received a SCI format-one at subframe tm+q*Pstep*Prsvp_RX, indicating the number of reserved resources with a higher priority that overlaps with Rx,y+j*P′rsvp_TX where q=1, 2, . . . , Q and J=0, 1, . . . , Cresel−1. The value Q=1/Prsvp_RX if Prsvp_RX<1 and y−m<=Pstep*Prsvp_RX+Pstep and if ty is the last subframe of the Y subframes, Q=1.
7. If the number of candidate single-subframe in the set of Sa is smaller than 0.2*Mtotal, then the Tha,b in the step 3 is increased by 3 dB.
8. For the remaining Rxy subframe resources in the set Sa. The metric Exy is defined as average S-RSSI in subchannel x+k for k=0, . . . , Lsubch−1 in the subframe resource ty−Pstep*j.
9. The UE moves the candidate resources having the smallest Exy from Sa to Sb such that the number of available subframe resource in the Sb reaches to the 0.2*Mtotal.
10. In the case of multi carriers, the UE removes subframe resources Rxy from Sb when the UE does not support the muti-carriers feature.

The UE reports the set Sb to higher layers.

Autonomous resource selection in NR sidelink (i.e. mode 2) was enhanced to support, e.g., different cast communications, i.e., broadcast, unicast and groupcast. The following subsections detail the radio resource selection procedure in NR-V2X Mode 2 [2]:

The higher layer may request the UE to report the subframe resources considering some parameters, e.g., priority (received and transmit), configured resource pool, packet delay budget, radio resource reservation, that can be used by higher-layer for control or data transmission.

The UE considers the following parameters during the subframe resources selection process:
T2minSelectionWindow: the minimum time that is used in the resource selection window and configured by higher layers.
SL-ThresRSRP_pi_pj: RSRP threshold for the received priority pi in SCI format 0-1, and transmission priority pj configured by the higher layer.
Rsforsensing: it determines that the RSRP in control or data channels is taken into consideration.
T0_Sensing_Window: it is the number of measured slots that are considered during the candidate resource selection process.
reservationPeriodAllowed.

Besides, Prsvp_TX is a transmission reservation period, which can be converted to the logical slot, P′rsvp_tx, when it is needed.

Similar to LTE V2X Mode 4 [1], in NR V2X Mode 2 [2], the resource selection process is performed as follows:
1. The UE selects a slot Rxy for transmission, where it consists of LsubCH contiguous radio resource starting from x+j wherein j=0, 1 . . . LsubCH−1. The UE would select a slot with respect to the resource pool between [n+Tproc,1,n+T2], where Tproc,1 and T2 values are up to UE implementation, and T2 should be between T2 min and PDB time when T2 min is configured. Otherwise, it is set to the remaining PDB. Note that, Mtotal is the total available slot radio resources for the transmission.
2. The UE monitors the slots withing the sensing window, as mentioned earlier.
3. Th(pi) is configured by the higher layer.
4. All slots radio resources comprise a set of Sa.
5. The UE excludes Rxy from Sa when the following conditions are met:
   a. The UE has not monitored the slot.
   b. SCI format 0-1 indicates that ‘Resource Reservation period’ is set, and no subchannels are available for a particular slot.
   c. SCI format 0-1 indicates that radio resources are reserved and priority value is higher than the transmission priority.
   d. Measured RSRP value is higher than Th(prior_RX) received in SCI format 0-1.
   e. When the ‘Resource Reservation Period’ field is set on the received SCI format 0-1 at the tm+q*P′rsvp_RX which overlaps with Rxy+jP′rsvp_TX where q=1, 2, . . . , Q and j=0, 1, 2, . . . , Cresel−1. Note that P′rsvp_RX is a logical slot that is obtained from Prsvp_RX and Q=Roof (Tscal/Prscvp_RX) if Rrsvp_RX<Tscal. Where Tscal is the remaining time to the packet delay budget. And n′<=m+P′rsvp_RX, where n=n′ when slot n belongs to the reserved transmission time period, otherwise it is the first slot after n in the range of configured transmission slots.
   f. When the number of candidate slot resources is less than 0.2*Mtotal, then Th(pi) is increased by 3 db and reinitiates the resource selection procedure.

The UE reports the Sa to the higher layers.

As indicated above, for LTE V2X mode 4, a P-UE should use the partial sensing configuration when it is used. For example, when the P-UE needs to save energy. The partial sensing limits the sensing instances in the P-UE, aiming to reduce the UE power consumption. Provided that the partial sensing in LTE V2X is used as a baseline for the NR V2X Mode 2, as state in the WI description [8], embodiments described herein address the following problems:
In frequency band FR1, i.e., less than 6 GHz, the subcarrier spacings 15, 30, 60 kHz were agreed to be configured for every bandwidth part (BWP). A higher subcarrier spacing calls for a shorter subframe size for data transmission, and thus subframe_NR=subframe_LTE/2\hat{ }u, where u=0, 1, 2 corresponds to the SCS=2\hat{ }u*15 kHz (i.e. SCS of of 15, 30, 60 kHz). In LTE V2X mode 4, when partial sensing is configured, Pstep is set to 100, and one subframe is monitored with different k*Pstep periodicity where k is a string/vector/list of partial sensing time instances and can be configured by the higher layer as mentioned earlier. This way, when looking in NR V2X mode 2, embodiments consider the impact of the subcarrier spacing on the Pstep size in order to have the same measurement results in different numerologies.
The P-UE identifies the candidate subframe resources, i.e., Step 1, and selects the radio resources for initial transmission and re-transmission, i.e., Step 2. Since the P-UE may not be able to identify the candidate radio resources or detect the resources during the partial sensing, it would be advantageous when a P-UE continues the partial sensing and re-evaluates the radio resources before triggering data (re-)transmission. To this aim, embodiments use a new partial sensing configuration after initial partial sensing and first candidate subframe resource selection to improve the quality of service and avoid any possible collision while saving the power in the pedestrian users.

In LTE V2X Mode 4, when partial sensing is configured, Pstep is set to 100, and one slot or part of a slot is monitored in every k*Pstep, where k is a string, vector or list of partial sensing time instances which are configured by higher layer. Since the LTE latency requirements is bounded to 100 slots [6], where a slot corresponds to a subframe length as per LTE definition, the Pstep size of 100 seems to be a viable value by which the application requirements in LTE can be fulfilled. In NR, new use cases such as advanced driving, platooning, extended sensors and remote driving have emerged, which have less latency and high reliability requirements compared with thereof in the LTE. The NR Mode 2 supports different numerologies, e.g., 15, 30, 60 KHz whereby the shorten slot duration can be achieved, through which the latency requirements can be fulfilled. Besides, many techniques are applied to 16efinitio the reliability requirements such as packet duplication and HARQ feedback. Table 2 illustrates some of the requirements as mentioned earlier for different use cases in V2X communication.

TABLE 2
Latency requirements for Vehicular Communication Use Cases [5]

| | Max | | |
|---|---|---|---|
| | End-to-End | | |
| Use Case | Latency (ms) | Relibility (%) | Comment |
| Cooperative | 10, 20, 25 | 90 ~ 99.99 | Depending on |
| Driving | | | the degree of |
| | | | automation |
| Advanced | 3, 10, 25, 100 | 99.99 | E.g. Collision |
| Driving | | | avoidance |
| Extended | 3, 10, 50, 100 | 99.99 ~ 99.999 | E.g. Sensor |
| Sensors | | | information |
| | | | sharing |
| | | | between Ues |
| Remote Driving | 5 | 99.999 | |

The present invention provides approaches for improving the partial sensing procedure of battery operated Ues, for example, VRU-Ues, such as P-Ues, so as to provide, for example, improvements, for example, in terms of power consumption, flexibility, complexity, forward compatibility, overhead, latency, robustness, reliability.

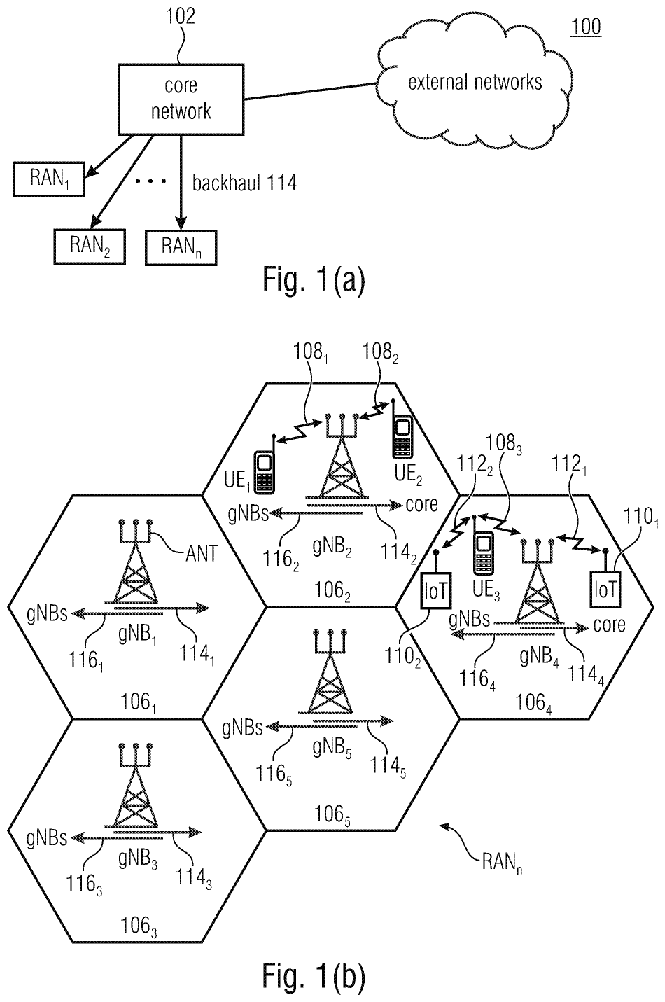

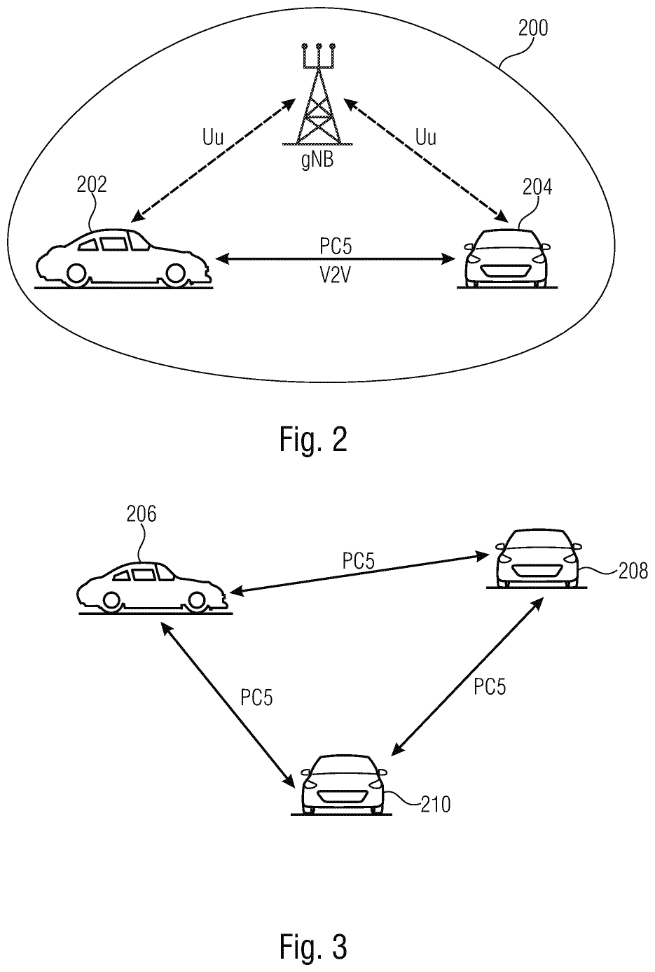

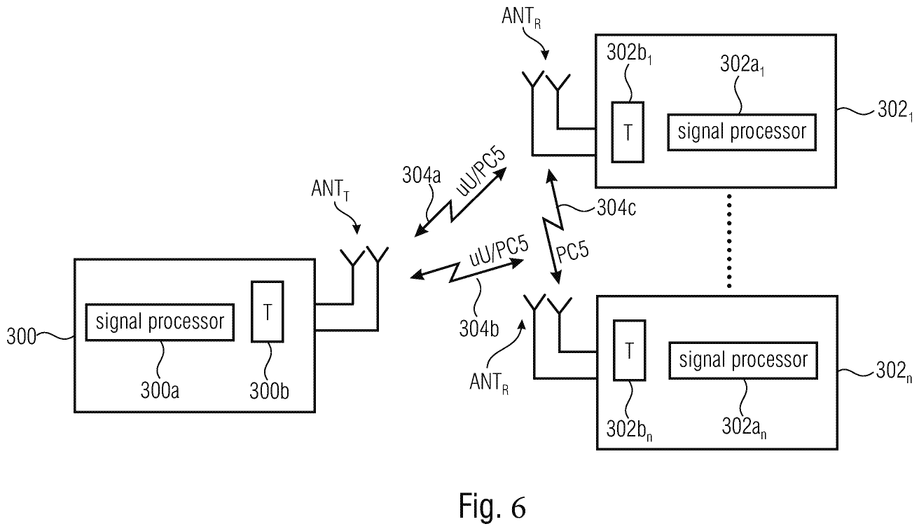

Embodiments of the present invention may be implemented in a wireless communication system as depicted in FIG. 1, FIG. 2, and FIG. 3 including base stations and users, like mobile terminals or IoT devices. FIG. 6 is a schematic representation of a wireless communication system including a central transceiver, like a base station, and one or more transceivers 3021 to 302n, like user devices, Ues. The central transceiver 300 and the transceivers 302 may communicate via one or more wireless communication links or channels 304a, 304b, 304c, like a radio link. The central transceiver 300 may include one or more antennas ANTT or an antenna array having a plurality of antenna elements, a signal processor 300a and a transceiver unit 300b, coupled with each other. The transceivers 302 include one or more antennas ANTR or an antenna array having a plurality of antennas, a signal processor 302a1, 302an, and a transceiver unit 302b1, 302bn coupled with each other. The base station 300 and the Ues 302 may communicate via respective first wireless communication links 304a and 304b, like a radio link using the Uu interface, while the Ues 302 may communicate with each other via a second wireless communication link 304c, like a radio link using the PC5 interface. When the Ues are not served by the base station, are not be connected to a base station, for example, they are not in an RRC connected state, or, more generally, when no SL resource allocation configuration or assistance is provided by a base station, the Ues may communicate with each other over the sidelink. The system, the one or more Ues and the base stations may operate in accordance with the inventive teachings described herein.

Embodiments provide a transceiver [e.g., VRU-UE] of a wireless communication network, wherein the transceiver is configured to operate in a sidelink in-coverage, out of coverage or partial coverage scenario [e.g., NR sidelink mode [e.g., mode 1 or mode 2]], in which the transceiver is configured or preconfigured to allocate or schedule resources for a sidelink communication [e.g., transmission and/or reception] over a sidelink autonomously or network controlled, wherein the transceiver is configured to determine, for said sidelink communication, a set of candidate resources [e.g., candidate resource elements] out of resources of the sidelink [e.g., sub-channels, a resource pool or a bandwidth part] by means of partial sensing [e.g., non-continuous sensing [or monitoring]] said resources of the sidelink prior to a sidelink transmission [e.g., of data [e.g., a data packet] or control information] to another transceiver of the wireless communication network, wherein the transceiver is configured to perform said sidelink transmission [e.g., at time instance m] using selected resources selected out of the set of candidate resources, wherein at least one parameter of the partial sensing depends on at least one out of
a state of the transceiver [e.g., battery status, geo location, DRX/DTX configuration, or network coverage],
a state of the wireless communication network [e.g., a number of other transceivers [e.g., VRU-Ues] in an area],
parameters of the sidelink or the sidelink communication [e.g., subcarrier spacing, available sub-channels/resource pool(s)/bandwidth part, HARQ configuration, configured grants (type 1, type 2), traffic type, cast type, QoS parameters or communication range],
a received control information.

In embodiments, the transceiver is configured to perform said partial sensing and said sidelink transmission during a discontinuous transmission, DTX, and/or a discontinuous reception, DRX, wherein the parameters of the discontinuous transmission, DTX, and/or discontinuous reception, DRX, depend on at least one parameter of the transceiver or the wireless communication network.

In embodiments, the at least one parameter of the partial sensing is at least one out of
a step size [e.g., Pstep] from which a time interval between two consecutive sensing intervals of the partial sensing is dependent [e.g., a time interval between two consecutive sensing intervals is a factor of the step size], time instances of the partial sensing,
a duration of the [e.g., non-contiguous] sensing of the partial sensing.

In embodiments, the transceiver is configured to adaptively adjust at least one parameter of the partial sensing depending on at least one out of
the state of the transceiver,
the state of the wireless communication network,
the parameters of the sidelink or the sidelink communication.

In embodiments, the transceiver is configured to adjust at least one parameter of the partial sensing depending on a received control information [e.g., RRC, DCI, or SCI] [e.g., received for the sidelink from another transceiver, a base station or operator of the wireless communication network] [e.g., wherein the control information comprises an information about the state of the wireless communication network or the parameter of the sidelink or the sidelink communication].

In embodiments, the control information is transmitted on either physical layer [e.g. DCI or SCI] or higher layers [e.g. RRC].

In embodiments, the at least one parameter of the partial sensing is pre-configured [e.g., in dependence on the state of the wireless communication network or the parameter of the sidelink or the sidelink communication].

In embodiments, the state of the transceiver is at least one out of
a geo location [e.g., position, zone, or validity area] of the transceiver,
a relative position of the transceiver with respect to another transceiver of the wireless communication network,
a status of a battery of the transceiver [e.g. Pbat],
a DRX/DTX configuration,
a network coverage [e.g., in coverage, out of coverage, or partial coverage].

In embodiments, the parameters of the sidelink or the sidelink communication are at least one out of
a subcarrier spacing,
a type [e.g., traffic type, Ptr, or cast type, Ct] of the sidelink communication,
a QoS of the sidelink communication,
a priority of the sidelink communication [e.g., sidelink transmission],
HARQ configuration,
configured grants (type 1, type 2).

In embodiments, the state of the wireless communication network is at least one out of
a number of other transceivers, Np, that are in range of the transceiver,
a number of other transceivers, that are located in the same communication area [e.g., validity area or zone] than the transceiver,
a minimum communication range with respect to sidelink.

In embodiments, the transceiver is configured to select the step size out of a set of different step sizes in dependence on at least one out of
the state of the transceiver,
the state of the wireless communication network,
the parameters of the sidelink or the sidelink communication,
   and/or in dependence on a received control information that depends on at least one out of the state of the transceiver,
   the state of the wireless communication network,
   the parameters of the sidelink or the sidelink communication.

In embodiments, the transceiver is configured to determine the time instances of the sensing intervals of the partial sensing in dependence on the selected step size.

In embodiments, the transceiver is configured to determine the number of the sensing intervals of the partial sensing in dependence on at least one out of
the state of the transceiver,
the state of the wireless communication network,
the parameters of the sidelink or the sidelink communication,
   and/or in dependence on a received control information that depends on at least one out of
the state of the transceiver,
the state of the wireless communication network,
the parameters of the sidelink or the sidelink communication.

In embodiments, a duration of the sensing of the partial sensing in dependence on at least one out of
the state of the transceiver,
the state of the wireless communication network,
the parameters of the sidelink or the sidelink communication,
   and/or in dependence on a received control information that depends on at least one out of
the state of the transceiver,
the state of the wireless communication network,
the parameters of the sidelink or the sidelink communication.

In embodiments, the transceiver is configured to receive a control information [e.g., transmitted on a physical layer [e.g. DCI or SCI] or on a higher layer [e.g. RRC]], wherein the control information comprises an information about at least one configurable parameter [e.g., K or Pstep] of the partial sensing, wherein the transceiver is configured to determine time instances of the partial sensing in dependence on the at least one configurable parameter [e.g., Pstep, K].

In embodiments, the at least one configurable parameter includes a variable step size [e.g., Pstep] describing a time interval between two consecutive sensing intervals of the partial sensing is dependent, and wherein the at least one configurable parameter further includes a string, vector or list [e.g., K] indicating the time instances of the partial sensing in dependence on the variable step size.

For example, the transceiver can be configured to determine the time instances of the partial sensing based on the formula

Time Instances=m−K*Pstep.

In embodiments, the at least one configurable parameter includes a variable step size [e.g., Pstep] describing a time interval between two consecutive sensing intervals of the partial sensing is dependent, wherein the at least one configurable parameter further includes a first string, vector or list [e.g., K′] indicating segments a sensing window [e.g., T0] is divided into, and wherein the at least one configurable parameter further includes a second string, vector or list [e.g., K] indicating the time instances of the partial sensing in dependence on the variable step size within the corresponding segment.

In embodiments, the transceiver is configured to derive a duration of the segments based on the step size and a length of the second string, vector or list [e.g., K], wherein the transceiver is configured to determine time instances of the partial sensing further in dependence on the duration [P′step] of the segments.

For example, the transceiver can be configured to determine the time instances of the partial sensing based on the formula

Time Instances=m−(K′−1)*P′step−K*Pstep.

In embodiments, the transceiver is configured to determine the number of segments of the partial sensing in dependence on the sensing window and the duration of a segment.

For example, the transceiver can be configured to determine the number of the segments of the of the partial sensing based on the formula

$$Number of segments = ⌈ \frac{T 0}{{P}_{step}^{′} ( m s )} ⌉ , or ⌈ \frac{T 0 * {2}^{u}}{{P}_{step}^{′} ( slot )} ⌉ .$$

In embodiments, the at least one configurable parameter includes a variable step size [e.g., Pstep] describing a time interval between two consecutive sensing intervals of the partial sensing is dependent, wherein the at least one configurable parameter further includes a first string, vector or list [e.g., K′] indicating the configured segments in a sensing window [e.g., TO] is divided into, wherein the at least one configurable parameter further includes a second string, vector or list [e.g., K] indicating the time instances of the partial sensing in dependence on the variable step size within the corresponding segment, wherein the transceiver is configured to determine time instances of the partial sensing further in dependence on a third string, vector or list [e.g., K″] indicating time shifts that are applied to the time instances of the partial sensing indicated by the first string, vector or list [e.g., K] in the corresponding segments.

In embodiments, the transceiver is configured to apply the time shifts indicated by the third string, vector or list [e.g., K″] to the time instances of the partial sensing indicated by the second string, vector or list [e.g., K] using a circular shift function.

In embodiments, the received control information comprises an information about the third string, vector or list [e.g., K″], or wherein the transceiver is configured to determine the third string, vector or list [e.g., K″] randomly or based on an algorithm.

In embodiments, the transceiver is configured to derive a duration of the segments based on the step size and a length of the second string, vector or list [e.g., K], wherein the transceiver is configured to determine time instances of the partial sensing further in dependence on the duration [P′step] of the segments.

For example, the transceiver can be configured to determine the time instances of the partial sensing based on the formula

Time Instances=m−(K′−1)*P′step−f(K,K″)*Pstep,

wherein f is the circular shift function by which the value K′ shifts as much as the value k″-th to right or left in every segment differently.

In embodiments, the variable step size is indicated by the control information by means of different configuration types or indexes.

In embodiments, the transceiver is configured to receive a control information [e.g., transmitted on a physical layer [e.g. DCI or SCI] or on a higher layer [e.g. RRC]], wherein the control information comprises an information about at least one configurable parameter [e.g., time instances, or Pstep] of the partial sensing, wherein the transceiver is configured to determine a duration of sensing of the partial sensing in dependence on the at least one parameter [e.g., traffic density].

In embodiments, the sidelink communication is a new radio, NR, sidelink communication.

In embodiments, the transceiver is configured to operate in a new radio, NR, sidelink mode 1 or mode 2.

In embodiments, the transceiver is battery operated.

In embodiments, the transceiver is a vulnerable road user equipment, VRU-UE.

Further embodiments provide a method for operating a transceiver of a wireless communication network. The method comprises a step of operating the transceiver in a sidelink in-coverage, out of coverage or partial coverage scenario [e.g., NR sidelink mode [e.g., mode 1 or mode 2], in which resources for a sidelink communication [e.g., transmission and/or reception] are scheduled or allocated autonomously or network controlled. Further, the method comprises a step of determining, for said sidelink communication, a set of candidate resources [e.g., candidate resource elements] out of resources of the sidelink [e.g., a sub-channel, resource pool or bandwidth part] by means of partial sensing [e.g., non-continuous sensing [or monitoring]] said resources of the sidelink prior to a sidelink transmission [e.g., of data [e.g., a data packet] or control information] to another transceiver of the wireless communication network. Further, the method comprises a step of performing said sidelink transmission [e.g., at time instance m] using resources selected out of the determined set of candidate resources, wherein at least one parameter of the partial sensing depends on at least one parameter of the transceiver or of the wireless communication network.

Embodiments of the present invention, as mentioned above, provide improvements and enhancements of the partial sensing procedure of battery operated Ues, for example, VRU-Ues, such as P-Ues, as it may be employed in NR sidelink communications, like V2X communications or the like. In the following, several aspects of the present invention are described which provide for enhancements with regard to at least one out of power consumption, flexibility, complexity, forward compatibility, overhead, specification impact, latency and robustness. The subsequently described aspects may be used independently from each other or some or all of the aspects may be combined.

Embodiments of the present invention define a flexible power saving approach, for example, for NR V2X Mode 1 or Mode 2 based on partial sensing to reduce the UE's, e.g., P-UE's, power consumption, but also to meet the latency and reliability requirements of each V2X application as outlined above. In embodiments, partial sensing is performed on the resource pools including the time and frequency resources. The resource pools could be transmission pool(s), reception pool(s) or exceptional pool(s) which are applicable to both, Mode 1 and/or Mode 2. To this aim, in embodiments, the following parameters can be adjusted by the network, for example, through RRC or SCI signaling, when it is configured/instructed.

Embodiments of the present invention enhance the partial sensing for NR sidelink communications by means of at least one out of (i.e. one or a combination of more than one of) the following configuration options, so as to reduce the VRU-Ues power consumption:
1. Partial sensing step size, Pstep, for VRU-Ues can be configured (cf. Section 1).
2. Partial sensing time instances can be configured. A VRU-UE can perform partial sensing in different time instances (cf. Section 2).
3. Partial sensing segments can be configured using a time shift (cf. Section 3).
4. Partial sensing duration for a VRU-UE can be configured (cf. Section 4).
5. The partial sensing time instances, step size, and/or duration can be configured based on, e.g., environmental or traffic/cast specific or UE/network specific conditions (cf. section 5), such as but not limited to
   traffic type (aperiodic/periodic),
   HARQ disabled/enabled,
   Configured grant (type1, type2),
   DRX/DTX configuration,
   cast type (broadcast, groupcast, unicast),
   network coverage (in, out, partial),
   UE location (e.g. zone, validity area, geo-location),
   distance between Ues/UE density,
   (minimum) communication range,
   UE battery status,
   QoS.

In addition to the above-mentioned aspects, in embodiments, discontinuous transmission and reception (DTX, DRX) can be applied in conjunction with partial sensing in NR. In this case a UE, such as a P-UE, has to be active during the sensing period of the partial sensing while it can be inactive during the remaining time.

1. Configurable Sensing Step Size (Pstep)

In accordance with embodiments, the sensing step size, i.e., Pstep, is configurable for a UE performing partial sensing for NR sidelink communication.

In embodiments, the sensing step size (Pstep) refers to a time scale that two consecutive time instances are a factor of Pstep, and wherein two consecutive time instances are the time difference between two consecutive sensing durations.

In embodiments, the sensing step size can be preconfigured or configured by the base station or the network or the operator by higher layers, e.g., through RRC signaling, or the physical layer, e.g., through DCI or SCI signaling, or flexibly adapted based on other conditions, e.g., see Section 5.

In embodiments, the sensing step size may be adapted based on the power saving concept, the partial sensing duration and the number of sensing instances.

In embodiments, the UE can be a P-UE or any other type of VRU, e.g., pedestrian, cyclist, or any other VRU configured to perform the partial sensing, wherein the vulnerable user is in coverage, in partial coverage or out of coverage.

In embodiments, the sensing step size, Pstep, can be configured by different values as per configuration type, as shown in Table 3. Thereby, the sensing step size, Pstep, in Table 3Error! Reference source not found. may depend upon the latency and reliability requirements of the applications [5], which can be (pre-)configured, for example, through a RRC or DCI message in Mode 1 when the UE is in the coverage area or in Mode 2.

TABLE 3
Example of different Pstep values for different configuration types

| Configuration Type | Pstep Value (ms) | Pstep Value (slot) |
|---|---|---|
| Configuration type 1 | 3 | 3 * 2\hat{ }u |
| Configuration type 2 | 5 | 5 * 2\hat{ }u |
| Configuration type 3 | 10 | 10 * 2\hat{ }u |
| Configuration type 4 | 20 | 20 * 2\hat{ }u |
| Configuration type 5 | 25 | 25 * 2\hat{ }u |
| Configuration type 6 | 50 | 50 * 2\hat{ }u |
| Configuration type 7 | 100 | 100 * 2\hat{ }u |

In embodiments, the sensing step size, Pstep, can be quantified by slot (e.g., Pstep=3*2\hat{ }u, u=0, 1, 2, 3), where u corresponds to the subcarrier spacing in NR, i.e. SCS=2\hat{ }u*15 kHz, or time (e.g., 3 ms). K is a string/vector/list indicating the sensing time instances, whose length is the same length as the respective LTE configuration, i.e., 10 bits.

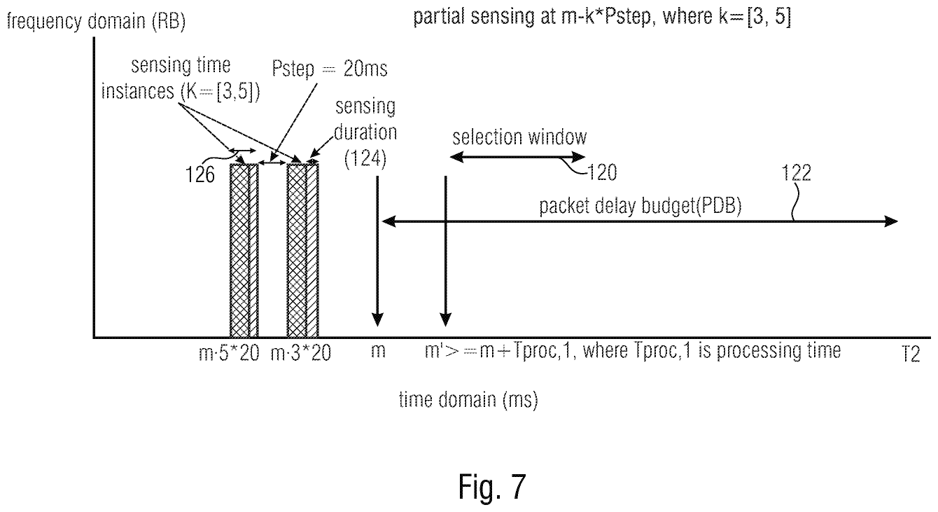

FIG. 7 shows a timeline based schematic representation of a partial sensing performed by UE for radio resource selection, in accordance with an embodiment of the present invention. In FIG. 7 it is exemplarily assumed that the UE performs, prior to the time instance m, partial sensing at sensing time instances m−k*Pstep for k=[3,5], i.e., at time instances m−5*Pstep and m−3*Pstep, wherein in FIG. 7 it is exemplarily assumed that Pstep=20 ms (Table 3, configuration type 4 and sub carrier spacing of 15 kHz). Further, in FIG. 7, time instance m′ indicates a start of transmission, which can take place at the start of a selection window 120, wherein m′=m+Tproc,1, wherein Tproc,1 is the processing time. As indicated in FIG. 7, the selection window 120 extends from time instance m′ to T2, wherein T2 is the packet delay budget 122 with respect to time instance m, as indicated by the duration 122 of the packet delay budget. As further indicated in FIG. 7, the sensing duration 124 can be shorter than a duration 126 of a slot. Naturally, the sensing duration 124 also could be equal to a slot duration 126.

In other words, FIG. 7 illustrates the partial sensing for a P-UE when K=[K3=1, K5=1], wherein configuration type 4 is (pre-)configured by the higher layers and subcarrier spacing is 15 kHz, i.e., slot duration is equal to 1 ms. In this scenario, when the packet arrives at the time instance m, the UE only performs sensing at the time instances of 60 ms and 100 ms and starts transmission at least at the time instance of T2>m′>=m+Tproc,1. Wherein Tproce,1 is processing time, and T2 is the maximum packet delay budget.

In embodiments, the parameter K for partial sensing can be set by the higher layer signaling. One possibility is via the RRC Information Element (IE) for UE autonomous resource selection as shown below, where, the gapCandidateSensing (=K) indicates which subframe should be sensed when a certain subframe is considered as a candidate resource.

Subsequently, an example for SL-CommTxPoolSensingConfig information element/UE-selectedConfig is provided:

-- ASN1START
-- TAG-SL-UE-SELECTEDCONFIG/ CommTxPoolSensingConfig-START

| | |
|---|---|
| SL-UE-SelectedConfig-r16 ::= | SEQUENCE{ |
| sl-PSSCH-TxConfigList-r16 | SL-PSSCH-TxConfigList-r16 |
| OPTIONAL, -- Need R | |
| sl-ProbResourceKeep-r16 | ENUMERATED {v0, v0dot2, v0dot4, v0dot6, |

v0dot8} OPTIONAL, -- Need R

| | |
|---|---|
| sl-ReselectAfter-r16 | ENUMERATED {n1, n2, n3, n4, n5, n6, n7, n8, |
| n9} OPTIONAL, -- Need R | |
| sl-PreemptionEnable-r16 | ENUMERATED {enabled} |
| OPTIONAL, -- Need R | |
| sl-CBR-CommonTxConfigList-r16 | SL-CBR-CommonTxConfigList-r16 |
| OPTIONAL, -- Need R | |
| ul-PrioritizationThres-r16 | INTEGER (1..16) |
| OPTIONAL, -- Need R | |
| sl-PrioritizationThres-r16 | INTEGER (1..8) |
| OPTIONAL, -- Need R | |
| thresPSSCH-RSRP-List-r16 | SL-ThresPSSCH-RSRP-List-r16, |

restrictResourceReservationPeriod-r16 SL-
RestrictResourceReservationPeriodList-r16 OPTIONAL, -- Need OR

| | |
|---|---|
| probResourceKeep-r16 | ENUMERATED {v0, v0dot2, v0dot4, v0dot6, |
| v0dot8, | |
| | spare3,spare2, spare1}, |
| p2x-SensingConfig-r16 | SEQUENCE{ |
| minNumCandidateSF-r16 | INTEGER (1..13), |
| gapCandidateSensing-r16 | BIT STRING (SIZE (10)) |
| } OPTIONAL, -- Need OR | |
| OPTIONAL, -- Need OR | |
| sl-ReselectAfter-r16 | ENUMERATED {n1, n2, n3, n4, n5, n6, n7, n8, n9, |
| | spare7, spare6, spare5, spare4, spare3, |
| spare2, | |
| OR | spare1} OPTIONAL -- Need |
| } | |
| -- TAG-SL-UE-SELECTEDCONFIG-STOP | |
| -- ASN1STOP | |

Based on the sensing results, the UE, e.g., P-UE, may select the resources based on the following resource selection configuration via RRC.

Subsequently, an example for SL-P2X-ResourceSelectionConfig information element is provided:

SL-P2X-ResourceSelectionConfig-r16 ::= SEQUENCE {

| | | | |
|---|---|---|---|
| partialSensing-r16 | ENUMERATD {true} | OPTIONAL, | -- Need OR |
| randomSelection-r16 | ENUMERATD {true} | OPTIONAL | -- Need OR |
| } | | | |
| -- ASN1STOP | | | |

For example, the P-UE can be configured based on the resource pool configuration as given e.g. in the SL-Resourcepool IE.

Subsequently, an example for SL-ResourcePool information element is provided:

-- ASN1START
-- TAG-SL-RESOURCEPOOL-START

| | |
|---|---|
| SL-ResourcePool-r16 ::= | SEQUENCE{ |
| sl-PSCCH-Config-r16 | SetupRelease { SL-PSCCH-Config-r16 } |
| OPTIONAL, -- Need M | |
| sl-PSSCH-Config-r16 | SetupRelease {SL-PSSCH-Config-r16 } |
| OPTIONAL, -- Need M | |
| sl-PSFCH-Config-r16 | SetupRelease { SL-PSFCH-Config-r16 } |
| OPTIONAL, -- Need M | |
| sl-SyncAllowed-r16 | SL-SyncAllowed-r16 |
| OPTIONAL, -- Need M | |
| sl-SubchannelSize-r16 | ENUMERATED {n10, n15, n20, n25, n50, n75, |
| n100} OPTIONAL, -- Need M | |
| sl-Period-r16 | ENUMERATED {ffs} |
| OPTIONAL, -- Need M | |
| sl-TimeResource-r16 | ENUMERATED {ffs} |
| OPTIONAL, -- Need M | |
| sl-StartRB-Subchannel-r16 | INTEGER (0..265) |
| OPTIONAL, -- Need M | |
| sl-NumSubchannel-r16 | INTEGER (1..27) |
| OPTIONAL, -- Need M | |
| sl-MCS-Table-r16 | ENUMERATED {qam64, qam256, qam64LowSE} |
| OPTIONAL, -- Need M | |
| sl-ThreshS-RSSI-CBR-r16 | INTEGER (0..45) |
| OPTIONAL, -- Need M | |
| sl-TimeWindowSizeCBR-r16 | ENUMERATED {ms100, slot100} |
| OPTIONAL, -- Need M | |
| sl-TimeWindowSizeCR-r16 | ENUMERATED {ms1000, slot1000} |
| OPTIONAL, -- Need M | |
| sl-PTRS-Config-r16 | SL-PTRS-Config-r16 |
| OPTIONAL, -- Need M | |
| sl-ConfiguredGrantConfigList-r16 | SL-ConfiguredGrantConfigList-r16 |
| OPTIONAL, -- Need M | |
| sl-UE-SelectedConfigRP-r16 | SL-UE-SelectedConfigRP-r16 |
| OPTIONAL, -- Need M | |
| sl-RxParametersNcell-r16 | SEQUENCE{ |
| sl-TDD-Config-r16 | TDD-UL-DL-ConfigCommon |
| OPTIONAL, | |
| sl-SyncConfiglndex-r16 | INTEGER (0..15) |
| resourceSelectionConfigP2X-r16 | SL-P2X-ResourceSelectionConfig-r16 |
| OPTIONAL, -- Cond P2X | |
| } | |
| OPTIONAL, -- Need M | |
| sl-ZoneConfigMCR-List-r16 | SEQUENCE (SIZE (16)) OF SL- |
| ZoneConfigMCR-r16 | OPTIONAL, -- Need M |
| ... | |
| } | |
| SL-ZoneConfigMCR-r16 ::= | SEQUENCE { |
| sl-ZoneConfigMCR-lndex-r16 | INTEGER (0..15), |
| sl-TransRange-r16 | ENUMERATED {m20, m50, m80, |

m100, m120, m150, m180, m200, m220, m250, m270, m300, m350,

m370, m400,

m420, m450, m480, m500, m550, m600, m700, m1000, spare8, spare7, spare6,

| | |
|---|---|
| | spare5, |
| spare4, spare3, spare2, spare1 } | OPTIONAL, -- Need M |
| sl-ZoneConfig-r16 | SL-ZoneConfig-r16 |

OPTIONAL, -- Need M
...
}

| | |
|---|---|
| SL-SyncAllowed-r16 ::= | SEQUENCE{ |
| gnss-Sync-r16 | ENUMERATED {true} |
| OPTIONAL, -- Need R | |
| gnbEnb-Sync-r16 | ENUMERATED {true} |
| OPTIONAL, -- Need R | |
| ue-Sync-r16 | ENUMERATED {true} |
| OPTIONAL -- Need R | |
| } | |
| SL-PSCCH-Config-r16 ::= | SEQUENCE { |
| sl-TimeResourcePSCCH-r16 | ENUMERATED {n2, n3} |
| OPTIONAL, -- Need M | |
| sl-FreqResourcePSCCH-r16 | ENUMERATED {n10,n12, n15, n20, n25} |
| OPTIONAL, -- Need M | |
| sl-DMRS-ScreamblelD-r16 | INTEGER (0..65535) |
| OPTIONAL, -- Need M | |
| sl-NumReservedBits-r16 | INTEGER (2..4) |
| OPTIONAL, -- Need M | |
| ... | |
| } | |
| SL-PSSCH-Config-r16 ::= | SEQUENCE { |
| sl-PSSCH-DMRS-TimePattern-r16 | ENUMERATED {ffs} |
| OPTIONAL, -- Need M | |
| sl-BetaOffsets2ndSCI-r16 | SEQUENCE (SIZE (4)) OF SL-BetaOffsets-r16 |
| OPTIONAL, -- Need M | |
| sl-Scaling-r16 | ENUMERATED {f0p5, fOp65, f0p8, f1} |
| OPTIONAL, -- Need M | |
| ... | |
| } | |
| SL-PSFCH-Config-r16 ::= | SEQUENCE { |
| sl-PSFCH-Period-r16 | ENUMERATED {sl0, sl1, sl2, sl4} |
| OPTIONAL, -- Need M | |
| sl-PSFCH-RB-Set-r16 | BIT STRING (SIZE (275)) |
| OPTIONAL, -- Need M | |
| sl-NumMuxCS-Pair-r16 | ENUMERATED {n1, n2, n3, n4, n6) |
| OPTIONAL, -- Need M | |
| sl-MinTimeGapPSFCH-r16 | ENUMERATED {sl2, sl3) |
| OPTIONAL, -- Need M | |
| sl-PSFCH-HoplD-r16 | INTEGER (0..1023) |
| OPTIONAL, -- Need M | |
| ... | |
| } | |
| SL-PTRS-Config-r16 ::= | SEQUENCE { |
| sl-PTRS-FreqDensity-r16 | SEQUENCE (SIZE (2)) OF INTEGER (1..276) |
| OPTIONAL, -- Need M | |
| sl-PTRS-TimeDensity-r16 | SEQUENCE (SIZE (3)) OF INTEGER (0..29) |
| OPTIONAL, -- Need M | |
| sl-PTRS-RE-Offset-r16 | ENUMERATED {offset01, offset10, offset11} |
| OPTIONAL, -- Need M | |
| ... | |
| } | |
| SL-UE-SelectedConfigRP-r16 ::= | SEQUENCE { |
| sl-CBR-Priority-TxConfigList-r16 | SL-CBR-Priority-TxConfigList-r16 |
| OPTIONAL, -- Need M | |
| sl-ThresPSSCH-RSRP-List-r16 | SL-ThresPSSCH-RSRP-List-r16 |
| OPTIONAL, -- Need M | |
| sl-MultiReserveResource-r16 | ENUMERATED {enabled} |
| OPTIONAL, -- Need M | |
| sl-MaxNumPerReserve-r16 | ENUMERATED {n2, n3} |

OPTIONAL, -- Need M

| | |
|---|---|
| sl-SensingWindow-r16 | ENUMERATED {ms100, ms1100} |
| OPTIONAL, -- Need M | |
| sl-SelectionWindow-r16 | ENUMERATED {n1, n5, n10, n20} |
| OPTIONAL, -- Need M | |
| sl-ResourceReservePeriodList-r16 | SEQUENCE (SIZE (1 ..16)) OF SL- |

ResourceReservePeriod-r16 OPTIONAL, -- Need M

| | |
|---|---|
| sl-RS-ForSensing-r16 | ENUMERATED {pscch, pssch}, |
| ... | |
| } | |
| SL-ResourceReservePeriod-r16 ::= | ENUMERATED {s0, s100, s200, s300, s400, s500, |
| s600, s700, s800, s900, s1000} | |
| SL-BetaOffsets-r16 ::= | INTEGER (0..31) |
| -- TAG-SL-RESOURCEPOOL-STOP | |
| -- ASN1STOP | |

2. Configurable Number of Sensing Time Instances

In accordance with embodiments, the number of the sensing time instances is configurable. This enables a UE, such as a P-UE, to perform partial sensing, when it is configured to do so, in the whole configured sensing window T0, e.g., T0=1100, when the sensing step size, i.e., Pstep, is configured differently.

In embodiments, the number of sensing time instances can be preconfigured or configured by the base station or the network or the operator by higher layers, e.g., through RRC signaling, or the physical layer, e.g., through DCI or SCI signaling, or flexibly adapted based on other conditions, e.g., see section 5.

For example, in accordance with the configurable number of sensing instances in the partial sensing, the new parameters K′ and P′step in addition to K and Pstep can be defined, wherein K′ and P′step indicate a sensing segment index and segment size within the sensing window T0 when the partial sensing is configured.

Thereby, note that, in embodiments, a sensing segment defines a time duration that is a factor of the sensing step size (Pstep). Within a sensing segment, the partial sensing parameters, e.g., the sensing step size, sensing time instance (with or without shift), and the sensing duration apply.

Wherein P′step is rounded up as follows:

P′step=Pstep*length(K). (2)

Thereby, u corresponds to the subcarrier spacing (SCS) and takes a value of u=0, 1, 2, and 3 for SCS of 15, 30, 60, and 120 kHz, respectively. The value of Pstep is the step size as earlier defined in Table 1.

Wherein K′ equals to [k′1 k′2 . . . k′N′] in which K′ value indicates the P′step-th segment within the sensing window T0. Furthermore, the length of K′, i.e., N′, yields as follows:

$${N}^{′} = ⌈ \frac{T 0}{{P}_{step}^{′} ( m s )} ⌉ , or ⌈ \frac{T 0 * {2}^{u}}{{P}_{step}^{′} ( slot )} ⌉ . \qquad ( 3 )$$

Wherein the partial sensing is performed at time instances indicated by the k′1 to k′N′ flags within the K′ segment as per configuration. Wherein K′ and K are configured by the higher layer signaling through RRC message, DCI or SCI signaling as shown by way of example below.

Subsequently, an example for SL-CommTxPoolSensingConfig information element/UE-selectedConfig is provided:

-- ASN1START
-- TAG-SL-UE-SELECTEDCONFIG/ CommTxPoolSensingConfig-START

| | |
|---|---|
| SL-UE-SelectedConfig-r16 ::= | SEQUENCE { |
| sl-PSSCH-TxConfigList-r16 | SL-PSSCH-TxConfigList-r16 |
| OPTIONAL, -- Need R | |
| sl-ProbResourceKeep-r16 | ENUMERATED {v0, v0dot2, v0dot4, v0dot6, |
| v0dot8} OPTIONAL, -- Need R | |
| sl-ReselectAfter-r16 | ENUMERATED {n1, n2, n3, n4, n5, n6, n7, n8, |
| n9} OPTIONAL, -- Need R | |
| sl-PreemptionEnable-r16 | ENUMERATED {enabled} OPTIONAL, -- Need R |
| sl-CBR-CommonTxConfigList-r16 | SL-CBR-CommonTxConfigList-r16 OPTIONAL, |
| -- Need R | |
| ul-PrioritizationThres-r16 | INTEGER (1..16) OPTIONAL, -- Need R |
| sl-PrioritizationThres-r16 | INTEGER (1..8) OPTIONAL, -- Need R |
| thresPSSCH-RSRP-List-r16 | SL-ThresPSSCH-RSRP-List-r16, OPTIONAL, |
| -- Need R | |

restrictResourceReservationPeriod-r16 SL-
RestrictResourceReservationPeriodList-r16 OPTIONAL, -- Need OR

| | |
|---|---|
| probResourceKeep-r16 | ENUMERATED {v0, v0dot2, v0dot4, v0dot6, |
| v0dot8, | |
| | spare3,spare2, spare1}, OPTIONAL, -- Need R |
| p2x-SensingConfig-r16 | SEQUENCE{ |
| minNumCandidateSF-r16 | INTEGER (1..13), OPTIONAL, -- Need R |
| gapCandidateSensing-r16 | BIT STRING (SIZE (10)) OPTIONAL, -- Need R |
| newgapCandidateSensing-r16 | BIT STRING (SIZE (10)) OPTIONAL, -- Need R |
| } OPTIONAL, -- Need R | |
| sl-ReselectAfter-r16 | ENUMERATED {n1, n2, n3, n4, n5, n6, n7, n8, |
| n9, | |
| | spare7, spare6, spare5, spare4, spare3, |
| spare2, | |
| | spare1} OPTIONAL -- Need OR |
| } | |

-- TAG-SL-UE-SELECTEDCONFIG-STOP

-- ASN1STOP

Where, the gapCandidateSensing (K) indicates which subframe should be sensed when a certain subframe is considered as a candidate resource and newgapCandidateSensing is the newly defined K′.

For example, in dependent upon definition Pstep in Section 1 and in accordance with the definition in Equation (2), in what follows, Table 4 exemplifies Pstep and P′step configuration, when T0 value is 1000, u=0:

TABLE 4
Example of Partial Sensing Configuration for Pstep and P′step.

| Configuration Type | Pstep Value (ms) | P′step Value (ms) |
|---|---|---|
| Configuration Type 1 | 3 | 30 |
| Configuration Type 2 | 5 | 50 |
| Configuration Type 3 | 10 | 100 |
| Configuration Type 4 | 20 | 200 |
| Configuration Type 5 | 25 | 250 |
| Configuration Type 6 | 50 | 500 |
| Configuration Type 7 | 100 | 1000 |

In accordance with another embodiment, a P-UE is going to transmit a packet at time instance, m′, and is configured to perform the partial sensing, wherein the duration of sensing window T0 is, for example, 1000 slots, the subcarrier spacing is, for example, 15 kHz, i.e., u=0, and the sensing step size Pstep is, for example, 10, and the length of K is, for example, 10, i.e., N=10.

According to Table 4 and Equation (3), for this example, P′step, N′ are 100 and 10, respectively. When a P-UE is configured with, for example, K=[k3=1, k5=1] and K′=[1, 2], it is mandated to monitor the time instances as indicated in the following Equation (4):

Partial Sensing Time Instances=m−(K′−1)*P′step−K*Pstep. (4)

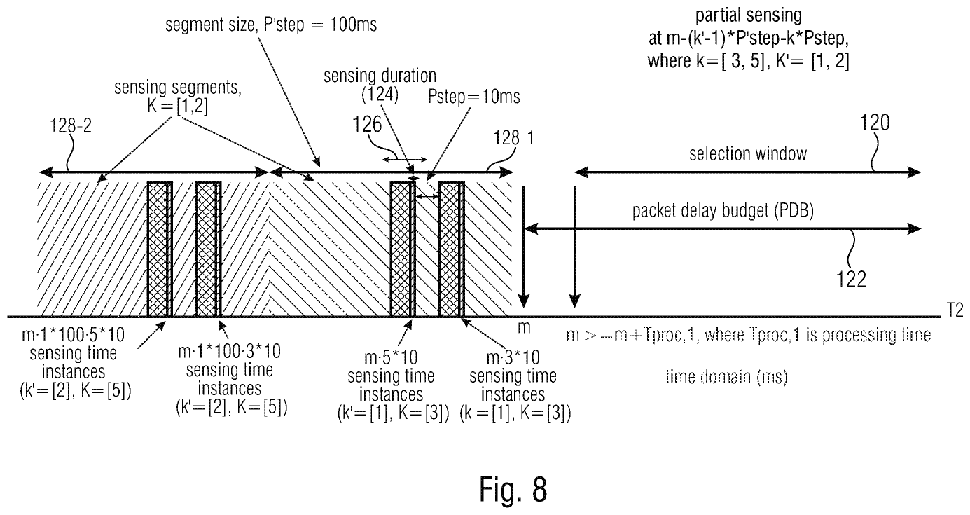

FIG. 8 illustrates the sensing time instance in the above example. In detail, FIG. 8 shows a timeline based schematic representation of a partial sensing performed by UE for radio resource selection, wherein partial sensing is performed based on sensing segments in accordance with an embodiment of the present invention. In FIG. 8 it is exemplarily assumed that the UE performs, prior to the time instance m, partial sensing in two sensing segments 128_1 and 128_2 at sensing time instances m−(k′−1)*Pstep−k*Pstep for k=[3, 5] and K′=[1, 2], i.e. at time instances m−1*P′step−5*Pstep, m−1*P′step−3*Pstep, m−5*Pstep, and m−3*Pstep, wherein in FIG. 8 it is exemplarily assumed that P′step=100 ms and Pstep=10 ms (Table 4, configuration type 3 and sub carrier spacing of 15 kHz). Further, in FIG. 8, time instance m′ indicates a start of transmission, which can take place at the start of a selection window 120, wherein m′=m+Tproc,1, wherein Tproc,1 is the processing time. As indicated in FIG. 8, the selection window 120 extends from time instance m′ to T2, wherein T2 is the packet delay budget 122 with respect to time instance m, as indicated by the duration 122 of the packet delay budget. As further indicated in FIG. 8, the sensing duration 124 can be shorter than a duration 126 of a slot. Naturally, the sensing duration 124 also could be equal to a slot duration 126.

3. Configurable Number of Segment-Based Sensing Time Instances with Different Shifts

In accordance with embodiments (e.g., alternatively to an embodiment of section 2), the partial sensing segments can be configured using a time shift. Wherein an offset K″ can be configured either randomly or based on an algorithm or in a coordinated manner and added to the K value in every segment. And the UE, e.g., P-UE, is mandated to perform the partial sensing on the configured time instances.

In embodiments, the number of segment-based sensing time instances with or without different shifts can be preconfigured or configured by the base station or the network or the operator by higher layers, e.g., through RRC signaling, or the physical layer, e.g., through DCI or SCI signaling, or flexibly adapted based on other conditions, e.g., see Section 5.

In embodiments, the length K″ can be configured equally to the length of K as per definition in LTE or can be configured different to the length of K as per requirements.

According to above definition, Equation (4) can be reformulated and yields:

Partial Sensing Time Instances=m−(K′−1)*P′step−f(K,K″)*Pstep.

Thereby, function f is a circular shift function by which the value K′ shifts as much as the value k″-th to right or left in every segment differently. The value K″=[k″1 . . . k″ N′] and N′ is the length of the vector K″. Besides, k″-th value can be set with a different value ranging between (1−N) to (N−1).

For example, a UE, such as a P-UE, is going to transmit a packet at time instance, m′, and is instructed to perform the partial sensing wherein duration of sensing T0 is, for example, 1000 slots, the subcarrier spacing u is, for example, 15 kHz, i.e., u=0, the sensing step size Pstep is, for example, 10, and the length of K is, for example, 10, i.e., N=10.

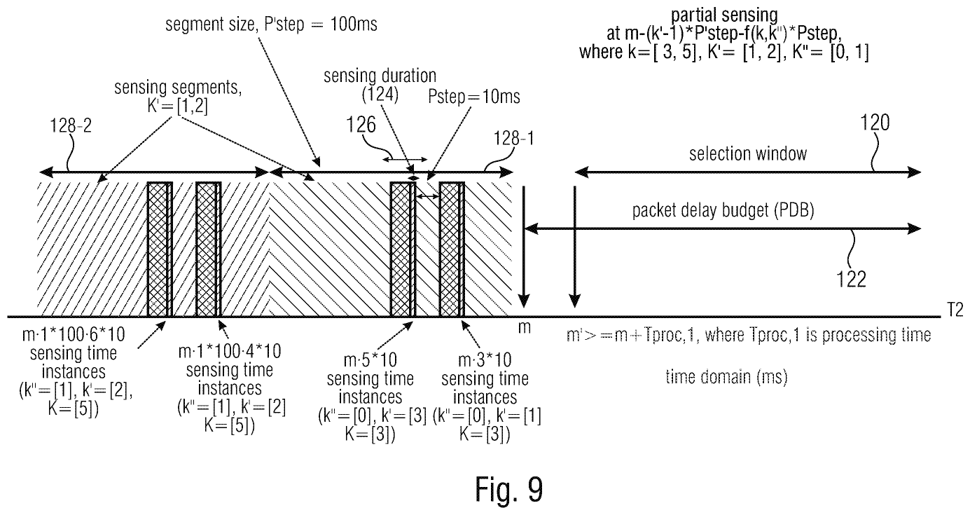

According to Table 4, P′step is 100. When a UE, such as a P-UE, is configured with K=[k3=1, k5=1], K′=[1, 2], and K″=[0, 1] it is mandated to perform the partial sensing in the segment #1 at K=[K3=1, K=5] and at segment #2 at time instances K=[K4=1, K6=1]. FIG. 9 illustrates the partial sensing applying offset value K″ in every segment.

In detail, FIG. 9 shows a timeline based schematic representation of a partial sensing performed by UE for radio resource selection, wherein partial sensing is performed based on sensing segments in accordance with an embodiment of the present invention. In FIG. 9 it is exemplarily assumed that the UE performs, prior to the time instance m, partial sensing in two sensing segments 128_1 and 128_2 at sensing time instances m−(k′−1)*Pstep−f(k′,k″)*Pstep for k=[3, 5], K′=[1, 2] and K″=[0, 1], i.e. at time instances m−1*P′step−6*Pstep, m−1*P′step−4*Pstep, m−5*Pstep, and m−3*Pstep, wherein in FIG. 9 it is exemplarily assumed that P′step=100 ms and Pstep=10 ms (Table 4, configuration type 3 and sub carrier spacing of 15 kHz). Further, in FIG. 9, time instance m′ indicates a start of transmission, which can take place at the start of a selection window 120, wherein m′=m+Tproc,1, wherein Tproc,1 is the processing time. As indicated in FIG. 9, the selection window 120 extends from time instance m′ to T2, wherein T2 is the packet delay budget 122 with respect to time instance m, as indicated by the duration 122 of the packet delay budget. As further indicated in FIG. 9, the sensing duration 124 can be shorter than a duration 126 of a slot. Naturally, the sensing duration 124 also could be equal to a slot duration 126.

In embodiments, the configuration of the parameter k can be done, for example, by the higher layer parameters as shown in example below.

Subsequently, an example of for SL-CommTxPoolSensingConfig information element/UE-selectedConfig is provided:

-- ASN1START
-- TAG-SL-UE-SELECTEDCONFIG/ CommTxPoolSensingConfig-START

| | |
|---|---|
| SL-UE-SelectedConfig-r16 ::= | SEQUENCE { |
| sl-PSSCH-TxConfigList-r16 | SL-PSSCH-TxConfigList-r16 |
| OPTIONAL, -- Need R | |
| sl-ProbResourceKeep-r16 | ENUMERATED {v0, v0dot2, v0dot4, v0dot6, v0dot8} |
| OPTIONAL, -- Need R | |
| sl-ReselectAfter-r16 | ENUMERATED {n1, n2, n3, n4, n5, n6, n7, n8, n9} |
| OPTIONAL, -- Need R | |
| sl-PreemptionEnable-r16 | ENUMERATED {enabled} |
| OPTIONAL, -- Need R | |
| sl-CBR-CommonTxConfigList-r16 | SL-CBR-CommonTxConfigList-r16 |
| OPTIONAL, -- Need R | |
| ul-PrioritizationThres-r16 | INTEGER (1..16) OPTIONAL, -- Need R |
| sl-PrioritizationThres-r16 | INTEGER (1..8) OPTIONAL, -- Need R |
| thresPSSCH-RSRP-List-r16 | SL-ThresPSSCH-RSRP-List-r16, |

restrictResourceReservationPeriod-r16 SL-
RestrictResourceReservationPeriodList-r16 OPTIONAL, -- Need OR

| | |
|---|---|
| probResourceKeep-r16 | ENUMERATED {v0, v0dot2, v0dot4, v0dot6, |
| v0dot8, | |
| | spare3,spare2, sparel}, OPTIONAL, -- Need R |
| p2x-SensingConfig-r16 | SEQUENCE { |
| minNumCandidateSF-r16 | INTEGER (1 ..13), OPTIONAL, -- Need R |
| gapCandidateSensing-r16 | BIT STRING (SIZE (10)) OPTIONAL, -- Need R |
| newgapCandidateSensing-r16 | BIT STRING (SIZE (10)) OPTIONAL, -- Need R |
| randomoffsetnewgapCandidateSensing-r16 | BIT STRING (SIZE (10)) |
| OPTIONAL -- Need OR | |
| } OPTIONAL, -- Need OR | |
| sl-ReselectAfter-r16 | ENUMERATED {n1, n2, n3, n4, n5, n6, n7, n8, n9, |
| | spare7, spare6, spare5, spare4, spare3, |
| spare2, | |
| | spare1} OPTIONAL -- Need |

OR
}
-- TAG-SL-UE-SELECTEDCONFIG-STOP
-- ASN1STOP

Where, the gapCandidateSensing (K) indicates which subframe should be sensed when a certain subframe is considered as candidate resource and randomoffsetnewgapCandidateSensing is the newly defined K″.

4. Configurable Sensing Duration

In accordance with embodiments, the sensing duration for a UE, such as a P-UE, can be configurable.

In embodiments, the sensing duration can be preconfigured or configured by the base station or the network or the operator by higher layers, e.g., through RRC signaling, or the physical layer, e.g., through DCI or SCI signaling, or flexibly adapted based on other conditions, e.g., see Section 5.

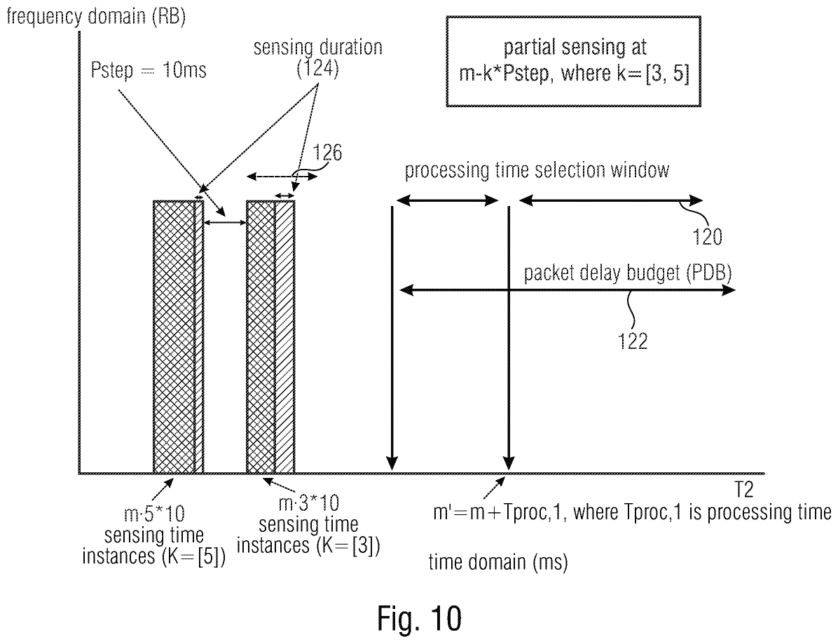

In embodiments, the length of the sensing duration can be based on a slot, wherein a slot is 1 ms/2\hat{ }u, where u=0, 1, 2, 3 for SCS=15 kHz*2\hat{ }u, i.e. 15, 30, 60, 120 kHz. Wherein, the slot duration can be configured by higher layers signaling, RRC message or SCI or DCI. Alternatively, the sensing duration also can be a fraction of a slot, for example, some symbols as per definition of the slot above. FIG. 10 illustrates an example of two different sensing durations for a scenario with K=[3, 5] and Pstep=10 ms.

In detail, FIG. 10 shows a timeline based schematic representation of a partial sensing performed by UE for radio resource selection, wherein sensing durations of the partial sensing are variable in accordance with an embodiment of the present invention. In FIG. 10 it is exemplarily assumed that the UE performs, prior to the time instance m, partial sensing at sensing time instances m−k*Pstep for k=[3,5], i.e. at time instances m−5*Pstep and m−3*Pstep, wherein in FIG. 10 it is exemplarily assumed that Pstep=10 ms. Further, in FIG. 10, time instance m′ indicates a start of transmission, which can take place at the start of a selection window 120, wherein m′=m+Tproc,1, wherein Tproc,1 is the processing time. As indicated in FIG. 10, the selection window 120 extends from time instance m′ to T2, wherein T2 is the packet delay budget 122 with respect to time instance m, as indicated by the duration 122 of the packet delay budget. As further indicated in FIG. 10, the sensing duration 124 can be shorter than a duration 126 of a slot. Naturally, the sensing duration 124 also could be equal to a slot duration 126.

5. Adapting Partial Sensing Configuration Parameters

Parameters described in Sections 1 to 4 to enhance the partial sensing procedure can be
(pre)configured, e.g., be operator settings, or
based on higher layer requirements, or
flexible adapted, e.g., as function
   based on, e.g., environmental or traffic/cast specific or UE/network/application/transmission specific conditions considering one or multiple of the following listed conditions (Note that these parameters include the sensing step size (Pstep), the number of sensing time instances, and the sensing duration):
Traffic type, e.g., aperiodic/periodic traffic.
HARQ disabled/enabled.
Configured grant (type1, type2).
DRX/DTX configuration.
Cast type (broadcast, groupcast (multicast), unicast).
Network coverage (in/partial/out).
UE position—e.g., geo-position, area the UE is located, relative position to other Ues:
   Geographical position of the UE, e.g., in vicinity to roads or junction/intersection,
   Areas the UE is located, e.g., zone, validity area,
   distance between Ues/UE density,
Minimum communication range: parameter included in SCI.
UE battery charge level, e.g. a threshold based on the battery charge level (e.g. low battery, such as 20% battery charge level) based on which the partial sensing parameters are adapted to further reduce the energy consumption.
QoS parameters, i.e., at least priority, reliability:
   Additionally, the priority of the transmission could be considered as a function to adapt the partial sensing parameters.
   For example:
      For high priority transmissions the sensing duration and number of partial sensing instances can be increased to increase the chance to allocate the resources; this function may additionally depend on the traffic condition. (Note: By increasing the number of sensing instances and sensing duration, the chance of a collision can be reduced. The chance of resource allocation will not change. In any case, resources can be allocated (a good or bad selection is maded based on how much information is available)).
      For low priority transmissions the sensing duration and number of partial sensing instances can be reduced to further decrease the energy consumption.

According to the above definition, in accordance with embodiments, a function f can be defined, e.g., by higher layers through which the sensing duration and interval for every UE, such as P-UE, or group of Ues, such as P-Ues, in an area indicated by zone/validity area as per the definition in Section 5 and Sections 1 to 4, are configured.

For example, the function f can be defined as follows:

[Tsen,K,K′,K″,Pstep]=f(Ptr,Zone,Pbat,Ct,Np), (6)

where Tsen, K, K′, and K″ are sensing duration and number of sensing time instances per 39efinition above, respectively. The variable Ptr is traffic type of P-UE and zone indicates geographical area of P-UE. Other parameters, Pbat, Ct and Np are battery status, cast communication and number of P-UE and non P-Ues in an area, respectively.

For example, when the battery status of a UE, such as a P-UE, is lower than a configured threshold, the sensing duration and number of partial sensing instances can be reduced to save more energy, if the quality of service requirements of an application can still be met.

Another example, when a UE, such as a P-UE, approaches to a hazardous area, e.g., junction, or an area with high-density traffic (e.g., based on geo-location, zone or validity area) the function adapts the sensing duration and duration accordingly.

6. Further Embodiments

Embodiments described herein provide a power reduction of VRU Ues using V2X applications. Opposite to vehicular mounted UE connected to the vehicles power supply, power reduction for the VRU using battery-based UE is very important. This is also requested in the Rel-17 WI as one major objective.

Embodiments described herein can be implemented according to a 5G NR V2X standard.

In accordance with embodiments, VRU Ues exposed to traffic, e.g., pedestrians, cyclists, scooter, and any other type of VRU are the potential application areas demanding these power saving procedures for V2X application. Even electronic vehicles and e-bikes may consider energy saving for their equipped Ues.

In accordance with embodiments, sensing is a continuously performed procedure by V2X Ues in mode 2 (expected as the common V2X mode for direct communication), consuming continuously and significantly the UE's limited battery power. Specially to ensure safety-critical V2X application, energy saving for VRUs is essential.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

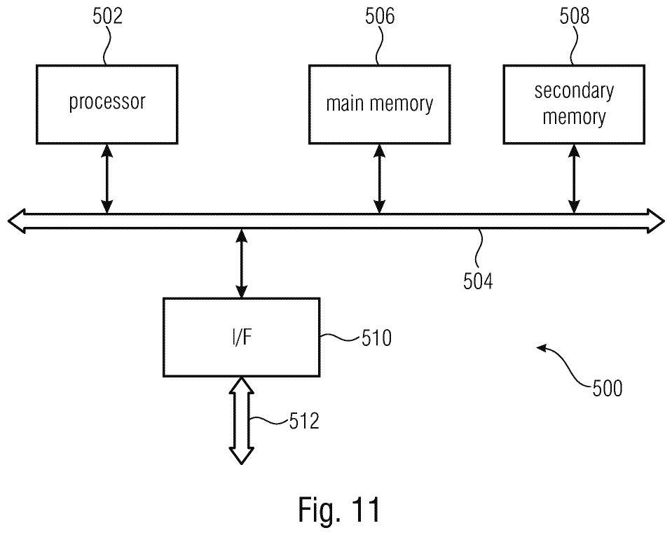

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 11 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### Abbreviations

VRU Vulnerable road user, typically using battery-based Ues for V2X applications.

VRUs include, e.g. pedestrians, cyclists and anybody else involved in traffic scenarios.
DRX Discontinuous reception
V-UE Vehicular User Equipment. A vehicular mounted UE
P-UE Pedestrian UE: should not be limited to pedestrians, but represents any UE with a need to save power, e.g. electrical cars, cyclicsts, other VRUs
WI Work Item
SCS Sub-Carrier Spacing
Pstep Sensing step size

### REFERENCES

[1] 3GPP TS 36.213 V15.8.0 (2019-12)
[2] 3GPP TS 38.214 V16.0.0 (2019-12)
[3] 3GPP TS 36.331 V15
[4] 3GPP TS 38.331 V16
[5] 3GPP TR 37.985 V1.1.0 (2020-02)
[6] 3GPP TS 22.186 V16.2.0
[7] 3GPP TS 22.185 V15.0.0
[8] 3GPP RP-19322, Work Item Description, NR Sidelink enhancements, Rel-17

1. A transceiver of a wireless communication network,
wherein the transceiver is configured to operate in a sidelink in-coverage, out of coverage or partial coverage scenario, in which the transceiver is configured or preconfigured to allocate or schedule resources for a sidelink communication over a sidelink autonomously or network controlled,
wherein the transceiver is configured to determine, for said sidelink communication, a set of candidate resources out of resources of the sidelink by means of partial sensing said resources of the sidelink prior to a sidelink transmission to another transceiver of the wireless communication network,
wherein the transceiver is configured to perform said sidelink transmission using selected resources selected out of the set of candidate resources,
wherein at least one parameter of the partial sensing depends on a discontinuous reception, DRX, and/or discontinuous transmission, DTX, configuration of the transceiver,
wherein the transceiver is configured to perform said partial sensing and said sidelink transmission during an active period of the discontinuous transmission, DTX, and/or an active period of the discontinuous reception, DRX,
wherein the parameters of the discontinuous transmission, DTX, and/or discontinuous reception, DRX, depend on at least one parameter of the transceiver or the wireless communication network,
wherein the at least one parameter of the partial sensing is at least one out of
a step size describing a time interval between two consecutive sensing intervals of the partial sensing is dependent,
time instances of the partial sensing,
a duration of the sensing of the partial sensing.

2. The transceiver according to claim 1,
wherein the transceiver is configured to adjust at least one parameter of the partial sensing in dependence on at least one out of
the state of the transceiver,
the state of the wireless communication network,
the parameters of the sidelink or the sidelink communication.

3. The transceiver according to claim 1,
wherein the transceiver is configured to adjust at least one parameter of the partial sensing depending on a received control information.

4. The transceiver according to claim 3,
wherein the control information is transmitted on either physical layer or higher layers.

5. The transceiver according to claim 1,
wherein the at least one parameter of the partial sensing is pre-configured.

6. The transceiver according to claim 1,
wherein the state of the transceiver is at least one out of
a geo location of the transceiver,
a relative position of the transceiver with respect to another transceiver of the wireless communication network,
a status of a battery of the transceiver,
a DRX/DTX configuration,
a network coverage.

7. The transceiver according to claim 1,
wherein the parameters of the sidelink or the sidelink communication are at least one out of
a subcarrier spacing,
a type of the sidelink communication,
a QoS of the sidelink communication,
a priority of the sidelink communication,
HARQ configuration,
configured grants (type 1, type 2).

8. The transceiver according to claim 1,
wherein the state of the wireless communication network is at least one out of
a number of other transceivers, Np, that are in range of the transceiver,
a number of other transceivers, that are located in the same communication area than the transceiver,
a minimum communication range with respect to sidelink.

9. The transceiver according to claim 1,
wherein the transceiver is configured to select the step size out of a set of different step sizes in dependence on at least one out of
the state of the transceiver,
the state of the wireless communication network,
the parameters of the sidelink or the sidelink communication,
and/or in dependence on a received control information that depends on at least one out of
the state of the transceiver,
the state of the wireless communication network,
the parameters of the sidelink or the sidelink communication.

10. The transceiver according to claim 9,
wherein the transceiver is configured to determine the time instances of the sensing intervals of the partial sensing in dependence on the selected step size.

11. The transceiver according to claim 1,
wherein the transceiver is configured to determine the number of the sensing intervals of the partial sensing in dependence on at least one out of
the state of the transceiver,
the state of the wireless communication network,
the parameters of the sidelink or the sidelink communication,
and/or in dependence on a received control information that depends on at least one out of
the state of the transceiver,
the state of the wireless communication network,
the parameters of the sidelink or the sidelink communication.

12. The transceiver according to claim 1,
wherein a duration of the sensing of the partial sensing in dependence on at least one out of
the state of the transceiver,
the state of the wireless communication network,
the parameters of the sidelink or the sidelink communication,
and/or in dependence on a received control information that depends on at least one out of
the state of the transceiver,
the state of the wireless communication network,
the parameters of the sidelink or the sidelink communication.

13. The transceiver according to claim 1,
wherein the transceiver is configured to receive a control information,
wherein the control information comprises an information about at least one configurable parameter of the partial sensing,
wherein the transceiver is configured to determine time instances of the partial sensing in dependence on the at least one configurable parameter.

14. The transceiver according to claim 13,
wherein the at least one configurable parameter comprises a variable step size describing a time interval between two consecutive sensing intervals of the partial sensing is dependent, and
wherein the at least one configurable parameter further comprises a string, vector or list indicating the time instances of the partial sensing in dependence on the variable step size.

15. The transceiver according to claim 13,
wherein the at least one configurable parameter comprises a variable step size describing a time interval between two consecutive sensing intervals of the partial sensing is dependent,
wherein the at least one configurable parameter further comprises a first string, vector or list indicating segments a sensing window is divided into, and
wherein the at least one configurable parameter further comprises a second string, vector or list indicating the time instances of the partial sensing in dependence on the variable step size within the corresponding segment.

16. The transceiver according to claim 15,
wherein the transceiver is configured to derive a duration of the segments based on the step size and a length of the second string, vector or list,
wherein the transceiver is configured to determine time instances of the partial sensing further in dependence on the duration of the segments.

17. The transceiver according to claim 16,
Wherein the transceiver is configured to determine the number of segments of the partial sensing in dependence on the sensing window and the duration of a segment.

18. The transceiver according to claim 13,
wherein the at least one configurable parameter comprises a variable step size describing a time interval between two consecutive sensing intervals of the partial sensing is dependent,
wherein the at least one configurable parameter further comprises a first string, vector or list indicating the configured segments in a sensing window is divided into,
wherein the at least one configurable parameter further comprises a second string, vector or list indicating the time instances of the partial sensing in dependence on the variable step size within the corresponding segment,
wherein the transceiver is configured to determine time instances of the partial sensing further in dependence on a third string, vector or list indicating time shifts that are applied to the time instances of the partial sensing indicated by the first string, vector or list in the corresponding segments.

19. The transceiver according to claim 18,
wherein the transceiver is configured to apply the time shifts indicated by the third string, vector or list to the time instances of the partial sensing indicated by the second string, vector or list using a circular shift function.

20. The transceiver according to claim 18,
wherein the received control information comprises an information about the third string, vector or list,
or wherein the transceiver is configured to determine the third string, vector or list randomly or based on an algorithm.

21. The transceiver according to claim 18,
wherein the transceiver is configured to derive a duration of the segments based on the step size and a length of the second string, vector or list,
wherein the transceiver is configured to determine time instances of the partial sensing further in dependence on the duration of the segments.

22. The transceiver according to claim 14,
wherein the variable step size is indicated by the control information by means of different configuration types or indexes.

23. The transceiver according to claim 1,
wherein the transceiver is configured to receive a control information,
wherein the control information comprises an information about at least one configurable parameter of the partial sensing,
wherein the transceiver is configured to determine a duration of sensing of the partial sensing in dependence on the at least one parameter.

24. The transceiver according to claim 1,
wherein the sidelink communication is a new radio, NR, sidelink communication.

25. The transceiver according to claim 1,
wherein the transceiver is configured to operate in a new radio, NR, sidelink mode 1 or mode 2.

26. The transceiver according to claim 1,
wherein the transceiver is battery operated.

27. The transceiver according to claim 1,
wherein the transceiver is a vulnerable road user equipment, VRU-UE.

28. A method for operating a transceiver of a wireless communication network, comprising:
operating the transceiver in a sidelink in-coverage, out of coverage or partial coverage scenario, in which resources for a sidelink communication are scheduled or allocated autonomously or network controlled,
determining, for said sidelink communication, a set of candidate resources out of resources of the sidelink by means of partial sensing said resources of the sidelink prior to a sidelink transmission to another transceiver of the wireless communication network,
performing said sidelink transmission using resources selected out of the determined set of candidate resources,
wherein at least one parameter of the partial sensing depends on a discontinuous reception, DRX, and/or discontinuous transmission, DTX, configuration of the transceiver,
wherein the transceiver is configured to perform said partial sensing and said sidelink transmission during an active period of the discontinuous transmission, DTX, and/or an active period of the discontinuous reception, DRX,
wherein the parameters of the discontinuous transmission, DTX, and/or discontinuous reception, DRX, depend on at least one parameter of the transceiver or the wireless communication network,
wherein the at least one parameter of the partial sensing is at least one out of
a step size describing a time interval between two consecutive sensing intervals of the partial sensing is dependent,
time instances of the partial sensing,
a duration of the sensing of the partial sensing.

29. A non-transitory digital storage medium having stored thereon a computer program for performing a method for operating a transceiver of a wireless communication network, comprising:
operating the transceiver in a sidelink in-coverage, out of coverage or partial coverage scenario, in which resources for a sidelink communication are scheduled or allocated autonomously or network controlled,
determining, for said sidelink communication, a set of candidate resources out of resources of the sidelink by means of partial sensing said resources of the sidelink prior to a sidelink transmission to another transceiver of the wireless communication network,
performing said sidelink transmission using resources selected out of the determined set of candidate resources,
wherein at least one parameter of the partial sensing depends on a discontinuous reception, DRX, and/or discontinuous transmission, DTX, configuration of the transceiver,
wherein the transceiver is configured to perform said partial sensing and said sidelink transmission during an active period of the discontinuous transmission, DTX, and/or an active period of the discontinuous reception, DRX,
wherein the parameters of the discontinuous transmission, DTX, and/or discontinuous reception, DRX, depend on at least one parameter of the transceiver or the wireless communication network,
wherein the at least one parameter of the partial sensing is at least one out of
a step size describing a time interval between two consecutive sensing intervals of the partial sensing is dependent,
time instances of the partial sensing,
a duration of the sensing of the partial sensing,
when said computer program is run by a computer.
